(19) United States
(12) Patent Application Publication
(10) Pub. No.: US 2025/0308169 A1
(43) Pub. Date: Oct. 2, 2025

(54) 3D MODELING METHOD AND ELECTRONIC DEVICE

(71) Applicant: SAMSUNG ELECTRONICS CO., LTD., Suwon-si (KR)

(72) Inventors: Younguk DO, Suwon-si (KR); Miyeon KIM, Suwon-si (KR); Gunhee LEE, Suwon-si (KR); Dohyun JO, Suwon-si (KR)

(73) Assignee: SAMSUNG ELECTRONICS CO., LTD., Suwon-si (KR)

(21) Appl. No.: 19/237,921

(22) Filed: Jun. 13, 2025

Related U.S. Application Data
(63) Continuation of application No. PCT/KR2023/017941, filed on Nov. 9, 2023.

(30) Foreign Application Priority Data
Dec. 14, 2022 (KR) 10-2022-0175303

(51) Int. Cl. G06T 19/00; G06T 17/00

(52) U.S. Cl. CPC G06T 19/00; G06T 17/00; G06T 2210/16

(57) ABSTRACT

A three-dimensional (3D) modeling method may include: receiving an image of a fabric and information associated with the fabric from a user; performing correction on the image of the fabric; and generating 3D images of a plurality of fabric products using the fabric based on the corrected image of the fabric and the received information associated with the fabric.

### CROSS-REFERENCE TO RELATED APPLICATION

This application is a continuation application is a continuation application, under 35 U.S.C. § 111(a), of international application No. PCT/KR2023/017941, filed Nov. 9, 2023, which claims priority under 35 U. S. C. § 119 to Korean Patent Application No. 10-2022-0175303, filed Dec. 14, 2022, the disclosures of which are incorporated herein by reference in their entireties.

### TECHNICAL FIELD

The disclosure relates to a three-dimensional (3D) modeling method and an electronic device that generates a 3D modeling image.

### BACKGROUND ART

Fabric products refer to interior and daily-life products made with fabric in people's living spaces, such as cushions, duvets, and curtains.

In order for a user to see a sample product made with fabric, an actual product had to be made with the corresponding fabric. In addition, an expert capable of operating software was required to provide a virtual graphic image of a fabric product using the software.

Accordingly, there is a growing demand for a method that may easily provide general users with fabric sample products in a virtual manner.

### DISCLOSURE

### Technical Problem

The disclosure provides a method for providing a three-dimensional (3D) image and a server that may provide a user with a desired fabric product design as a 3D image without directly producing the fabric product.

### Technical Solution

According to an aspect of the disclosure, a three-dimensional (3D) modeling method may include: receiving an image of a fabric and information associated with the fabric from a user; performing correction on the image of the fabric; and generating 3D images of a plurality of fabric products using the fabric based on the corrected image of the fabric and the received information associated with the fabric.

The method may further include generating a 3D image of the plurality of fabric products placed in a pre-modeled 3D space.

The receiving of the information about the fabric may include receiving information about a thickness and a weight of the fabric.

The performing correction of the image of the fabric may include performing correction for at least one of shadow, local illumination inhomogeneity, distortion, color, brightness, or pattern of the image of the fabric.

The generating of the 3D images may include generating 3D still images and 3D moving images corresponding to information about the plurality of fabric products.

The 3D modeling method may further include storing the generated 3D modeling images.

The storing of the generated 3D modeling images may include classifying the generated 3D modeling images by fabric type and storing the classified 3D modeling images respectively.

The 3D modeling method may further include displaying the generated 3D modeling images.

According to an aspect of the disclosure, an electronic device may include: an input module configured to allow a user to input an image of a fabric and information about the fabric; a memory; and at least one processor configured to generate a three-dimensional (3D) image of a fabric product, wherein the at least one processor may be configured to perform correction on the image of the fabric, and generate 3D images of a plurality of fabric products using the fabric based on the corrected image of the fabric and the received information about the fabric.

The at least one processor may be configured to generate a 3D image of the plurality of fabric products placed in a pre-modeled 3D space.

The at least one processor may be configured to receive information about a thickness and a weight of the fabric.

The at least one processor may be configured to perform correction for at least one of shadow, local illumination inhomogeneity, distortion, color, brightness, or pattern of the image of the fabric.

The at least one processor may be configured to generate 3D still images and 3D moving images corresponding to information about the plurality of fabric products.

The at least one processor may be configured to store the generated 3D modeling images in the memory.

The memory may include a storage space for each fabric type, and the at least one processor may be configured to classify the generated 3D modeling images by fabric type and store the classified 3D modeling images in each of the storage spaces.

The electronic device may further include an output module configured to output the generated 3D image, wherein the at least one processor may be configured to control the output module to output the generated 3D modeling images.

### Advantageous Effects

According to an aspect of the disclosure, a user may be provided with a desired fabric product design as a 3D image without directly producing the fabric product.

In addition, a fabric product is not actually manufactured, and thus convenience and efficiency may be increased.

### DESCRIPTION OF DRAWINGS

FIG. 1 is a control block diagram of an electronic device according to an embodiment.

FIG. 2 is a flowchart illustrating a three-dimensional (3D) modeling method according to an embodiment.

FIG. 3 is a diagram illustrating input of a fabric image according to an embodiment.

FIG. 4 is a diagram illustrating input of fabric information according to an embodiment.

FIG. 5 is a diagram illustrating classification of fabrics by physical property according to an embodiment.

FIG. 6 is a flowchart illustrating generation of a 3D image of a fabric product placed in a 3D space according to an embodiment.

FIG. 7 is a diagram illustrating a virtual 3D space in which fabric products are placed according to an embodiment.

FIG. 8 is a flowchart illustrating storage of a generated 3D modeling image according to an embodiment.

FIG. 9 is a control block diagram for storing a 3D modeling image according to an embodiment.

FIG. 10 is a flowchart illustrating display of a 3D modeling image of a fabric product according to an embodiment.

FIG. 11 is a diagram illustrating a displayed 3D modeling image of a fabric product according to an embodiment.

FIG. 12 is a control block diagram of a server that generates a 3D image and a user terminal according to an embodiment.

### MODES OF THE INVENTION

Embodiments described in the disclosure and configurations shown in the accompanying drawings are merely examples of the disclosure, and various modifications may replace the embodiments and the drawings of the disclosure at the time of filing of the application.

In addition, like reference numerals refer to like elements throughout the specification.

In addition, the terms used herein is for the purpose of describing particular embodiments only and is not intended to limit the disclosure. A singular form of a noun corresponding to an item may include one or more of the items unless clearly indicated otherwise in a related context. It will be understood that when the terms “includes”, “comprises”, “including”, and/or “comprising” are used in the disclosure, they specify the presence of the specified features, figures, steps, operations, components, members, or combinations thereof, but do not preclude the presence or addition of one or more other features, figures, steps, operations, components, members, or combinations thereof.

In addition, it is to be understood that when a certain component is referred to as being “connected to,” or “coupled with,” another component, it means that the component may be connected to or coupled with the other component directly or indirectly via a third component.

In addition, although the terms “first”, “second”, etc. may be used to describe various components, the terms do not limit the corresponding components, but are used only for the purpose of distinguishing one component from another. For example, without departing from the technical spirit or essential features of the disclosure, a first element may be referred to as a second element, and a second element may be referred to as a first element. As used herein, the term “and/or” includes any and all combinations of one or more of the associated listed items.

Hereinafter, an operating principle and embodiments of the disclosure will now be described with reference to accompanying drawings.

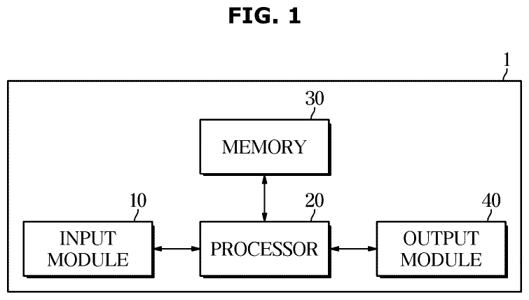

FIG. 1 is a control block diagram of an electronic device according to an embodiment.

An electronic device 1 may include an input module 10, an output module 40, at least one processor 20, and a memory 30.

The input module 10 may receive various inputs from a user. The user may input an image of a fabric and information about the fabric through the input module 10.

The electronic device 1 may include the memory 30 that stores a control program and control data for generating a three-dimensional (3D) image, and the at least one processor 20 that generates a control signal according to the control program and control data stored in the memory 30. The memory 30 and the processor 20 may be provided integrally or separately.

The memory 30 may store the generated 3D image, and store a program and data for generating the 3D image.

The memory 30 may include a volatile memory such as a static random access memory (S-RAM) and a dynamic random access memory (D-RAM) for temporarily storing data. In addition, the memory 30 may include a non-volatile memory such as a read only memory (ROM), an erasable programmable read only memory (EPROM), and an electrically erasable programmable read only memory (EEPROM) for long-term data storage.

The at least one processor 20 may refer to a central processing unit (CPU), a graphics processing unit (GPU), or a dedicated processor for performing the method according to embodiments of the disclosure.

The at least one processor 20 may include various logic circuits and operation circuits, and may process data according to a program provided from the memory 30 and generate a control signal according to the processing result.

The output module 40 may output the generated 3D image.

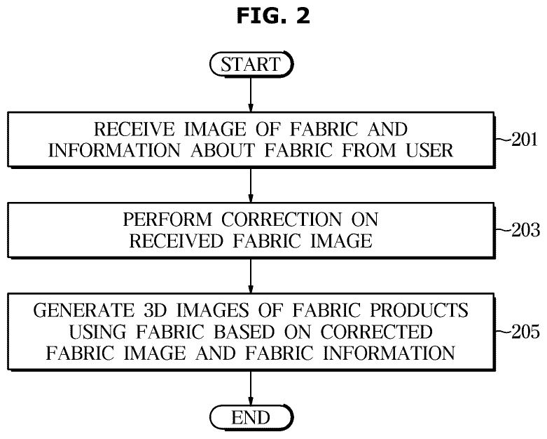

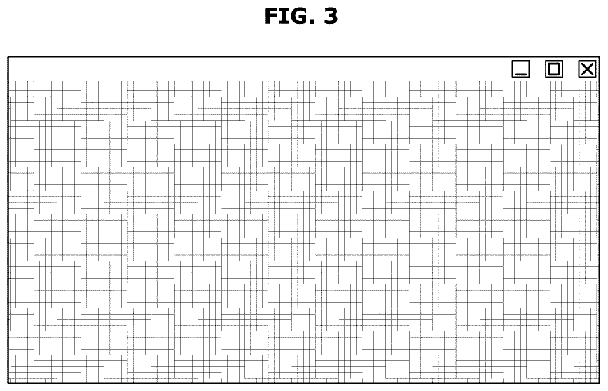

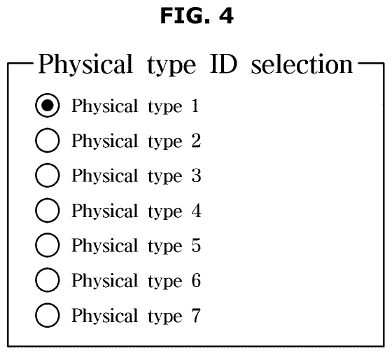

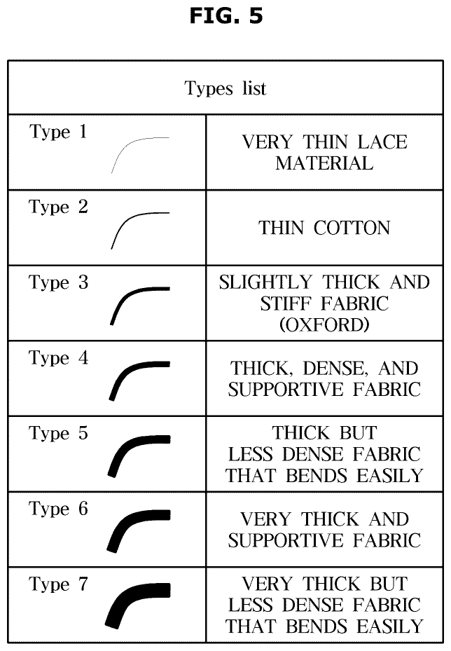

FIG. 2 is a flowchart illustrating a 3D modeling method according to an embodiment. FIG. 3 is a diagram illustrating input of a fabric image according to an embodiment. FIG. 4 is a diagram illustrating input of fabric information according to an embodiment. FIG. 5 is a diagram illustrating classification of fabrics by physical property according to an embodiment.

An image of a fabric (hereinafter also referred to as fabric image) and information about the fabric (hereinafter also referred to as fabric information) may be received from a user (201).

The fabric image may refer to an actual image of the fabric captured by a camera.

Once the fabric image is input as shown in FIG. 3, image correction and 3D image generation may be performed based on the input fabric image, which will be described below.

The fabric information may include information about a thickness and a weight of the fabric.

The user may directly enter (input) the thickness and weight information, or may enter the fabric information by selecting one from a plurality of physical properties classified as shown in FIG. 4.

Specifically, the thickness and weight information may be classified into seven types. However, the seven types are only an example, and more types may be used.

Referring to FIG. 5, type 1 may include a fabric which is a very thin lace material. In other words, a fabric having a thin thickness and light weight may be included in type 1.

Type 2 may include a fabric which is a thin cotton as a thicker and heavier material than type 1.

Type 3 may include a fabric which is slightly thick and stiff (Oxford).

Type 4 may include a fabric which is thick, dense, and supportive.

Type 5 may include a fabric which is thick, but less dense, and bends easily.

Type 6 may include a fabric which is very thick and supportive.

Type 7 may include a fabric which is very thick, but less dense, and bends easily.

The user may input information about the thickness and weight of the fabric by selecting a corresponding type, as shown in FIG. 4.

The at least one processor 20 may perform correction on the received image of the fabric (203).

Specifically, the at least one processor 20 may perform correction for at least one of shadow, local illumination inhomogeneity, distortion, color, brightness, or pattern of the fabric image.

The at least one processor 20 may adjust the brightness of each pixel for the received fabric image to correct the brightness as if uniform lighting were applied.

In addition, the most natural size of a pattern of a fabric may be determined by reducing or expanding an image of the fabric in the horizontal and vertical directions.

Further, by performing correction for shadow and distortion in the image of the fabric, a refined fabric image may be obtained.

The above-described operations of the at least one processor 20 are only an example of performing correction for the fabric image, and various corrections may be further performed for the received fabric image.

The at least one processor 20 may generate 3D images of a plurality of fabric products using the fabric, based on the corrected fabric image and the received fabric information (205).

For example, 3D images of various fabric products, such as cushions, duvets, and curtains using the fabric may be generated.

Here, generating 3D images may include generating 3D still images and 3D moving images corresponding to information about the plurality of fabric products.

That is, 3D still images and moving 3D moving images of the above-described various fabric products may be generated.

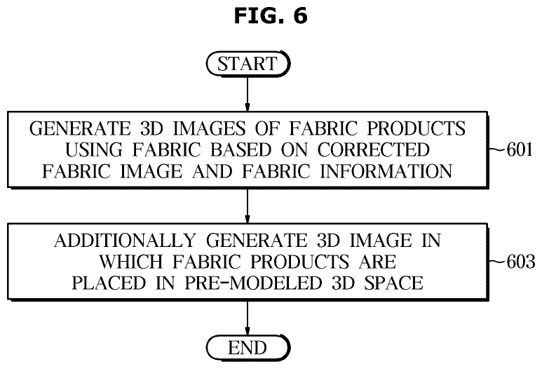

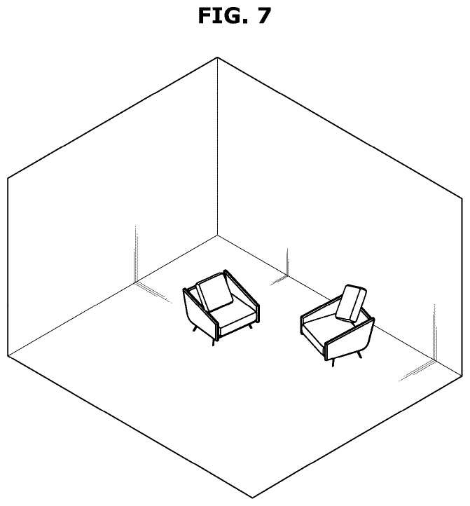

FIG. 6 is a flowchart illustrating generation of a 3D image of a fabric product placed in a 3D space according to an embodiment. FIG. 7 is a diagram illustrating a virtual 3D space in which fabric products are placed according to an embodiment.

The at least one processor 20 may generate the 3D images of the plurality of fabric products using the fabric based on the corrected fabric image and the received fabric information (601).

Here, the at least one processor 20 may additionally generate a 3D image in which the plurality of fabric products are placed in a pre-modeled 3D space (603).

As shown in FIG. 7, the 3D image of the fabric products may be arranged in a pre-modeled 3D space for the fabric product to be placed.

In a case where the generated fabric product is a cushion, a 3D image in which the cushion is placed on a sofa in a pre-modeled 3D space prepared with the sofa may be generated, thereby allowing the user to see the fabric product being placed in an actual space.

The fabric product may be placed in the pre-modeled virtual 3D space and captured at various angles, thereby allowing the user to see the fabric product at various angles.

In addition, an auxiliary object having a high similarity to the generated fabric product may be placed together to enhance realism.

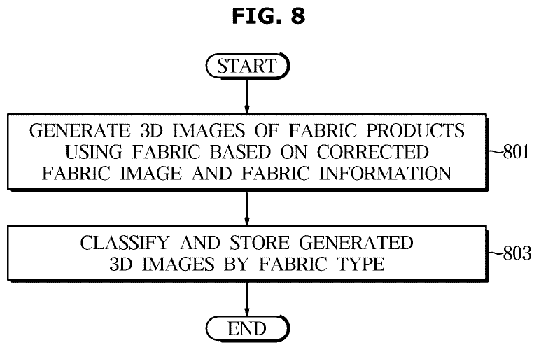

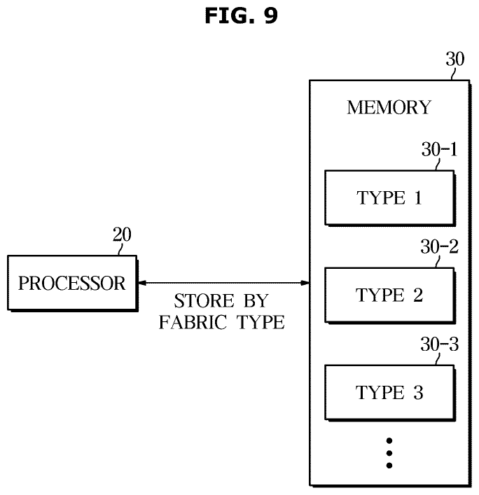

FIG. 8 is a flowchart illustrating storage of a generated 3D modeling image according to an embodiment. FIG. 9 is a control block diagram for storing a 3D modeling image according to an embodiment.

The at least one processor 20 may generate the 3D images of the plurality of fabric products using the fabric based on the corrected fabric image and the received fabric information (801).

The at least one processor 20 may store the generated 3D modeling images in the memory 30.

Specifically, the generated 3D modeling images may be classified and stored by fabric type (803).

To this end, the memory 30 may include a storage space for each fabric.

As shown in FIG. 9, the memory 30 may include a storage space for type 1 fabric, a storage space for type 2 fabric, and a storage space for type 3 fabric, and may include more types of storage spaces depending on the classification of the type of the fabric.

A 3D modeling image of a fabric product generated based on a type 1 fabric may be stored in a storage space corresponding to type 1 in the memory 30, a 3D modeling image of a fabric product generated based on a type 2 fabric may be stored in a storage space corresponding to type 2 in the memory 30, and a 3D modeling image of a fabric product generated based on a type 3 fabric may be stored in a storage space corresponding to type 3 in the memory 30.

By storing the 3D modeling images for each type of fabric, a user may conveniently check a 3D image of a fabric product.

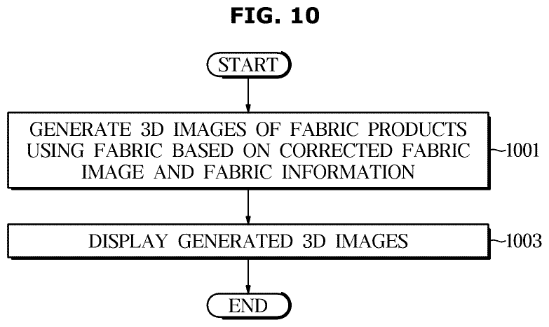

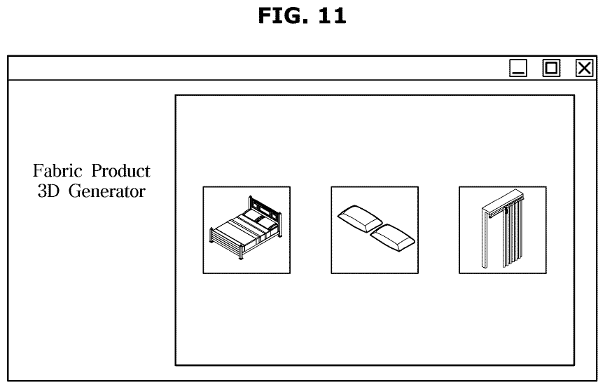

FIG. 10 is a flowchart illustrating display of a 3D modeling image of a fabric product according to an embodiment. FIG. 11 is a diagram illustrating a displayed 3D modeling image of a fabric product according to an embodiment.

The at least one processor 20 may generate the 3D images of the plurality of fabric products using the fabric based on the corrected fabric image and the received fabric information (1001).

The at least one processor 20 may control the output module 40 to output the generated 3D modeling images.

That is, in a case where 3D images of a bed, a cushion, and a curtain using the corresponding fabric are generated based on the corrected fabric image and the received fabric information, the generated 3D images of the bed, cushions, and curtain may be displayed to allow the user to view the generated 3D images.

The bed, cushions, and curtain of FIG. 11 are only examples of fabric products using the fabric, and various other fabric products that may be made using the fabric may be further included.

The user may be provided with the generated 3D images, thereby checking the fabric product without directly making a sample product with the fabric.

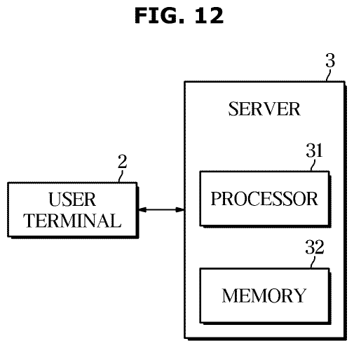

FIG. 12 is a control block diagram of a server that generates a 3D image and a user terminal according to an embodiment.

The above-described 3D modeling method may be performed by at least one server 3.

The server 3 may include a processor 31 and a memory 32, and user input may be performed by a user terminal 2.

The processor 31 may refer to a central processing unit (CPU), a graphics processing unit (GPU), or a dedicated processor for performing the method according to embodiments of the disclosure. The memory 32 may be configured as at least one of a volatile storage medium or a non-volatile storage medium. For example, the memory 32 may be one of read only memory (ROM) and random access memory (RAM).

The user terminal 2 may include a communicable desktop computer, laptop computer, smart phone, tablet PC, mobile phone, smart watch, smart glass, e-book reader, portable multimedia player (PMP), handheld game console, navigation device, digital camera, digital multimedia broadcasting (DMB) player, digital audio recorder, digital audio player, digital video recorder, digital video player, personal digital assistant (PDA), or the like.

The processor 31 may receive an image of a fabric and information about the fabric from a user through the user terminal 2, may perform correction on the image of the fabric, and may generate a control signal for generating 3D images of a plurality of fabric products using the fabric based on the corrected image of the fabric and the information about the fabric.

In addition, a program for executing the above-described 3D modeling method may also be implemented in the form of a recording medium.

According to an aspect of the disclosure, a user may be provided with a desired fabric product design as a 3D image without directly producing the fabric product.

In addition, a fabric product is not actually manufactured, and thus convenience and efficiency may be increased.

Meanwhile, the disclosed embodiments may be implemented in the form of a recording medium that stores instructions executable by a computer. The instructions may be stored in the form of program codes, and when executed by a processor, the instructions may create a program module to perform operations of the disclosed embodiments. The recording medium may be implemented as a computer-readable recording medium.

The computer-readable recording medium may include all kinds of recording media storing instructions that may be interpreted by a computer. For example, the computer-readable recording medium may be a read only memory (ROM), a random access memory (RAM), a magnetic tape, a magnetic disk, a flash memory, an optical data storage device, etc.

Although embodiments of the disclosure have been described with reference to the accompanying drawings, a person having ordinary skilled in the art will appreciate that other specific modifications may be easily made without departing from the technical spirit or essential features of the disclosure. Accordingly, the foregoing embodiments should be regarded as illustrative rather than limiting in all aspects.

1. A three-dimensional (3D) modeling method, comprising:
receiving an image of a fabric and information associated with the fabric from a user;
performing correction on the image of the fabric;
generating 3D images of a plurality of fabric products using the fabric based on the corrected image of the fabric and the received information associated with the fabric; and
generating a 3D image of the plurality of fabric products placed in a pre-modeled 3D space.

2. The 3D modeling method of claim 1, wherein the receiving of the information associated with the fabric comprises receiving information about a thickness and a weight of the fabric.

3. The 3D modeling method of claim 1, wherein the performing correction of the image of the fabric comprises performing correction for at least one of shadow, local illumination inhomogeneity, distortion, color, brightness, or pattern of the image of the fabric.

4. The 3D modeling method of claim 1, wherein the generating of the 3D images comprises generating 3D still images and 3D moving images corresponding to information associated with the plurality of fabric products.

5. The 3D modeling method of claim 1, further comprising:
storing the generated 3D images.

6. The 3D modeling method of claim 5, wherein the storing of the generated 3D images comprises classifying the generated 3D images by fabric type and storing the classified 3D images respectively.

7. The 3D modeling method of claim 1, further comprising:
displaying the generated 3D images.

8. An electronic device, comprising:
an input module configured to allow a user to input an image of a fabric and information associated with the fabric;
a memory; and
at least one processor configured to generate a three-dimensional (3D) image of a fabric product,
wherein the at least one processor is configured to perform correction on the image of the fabric, generate 3D images of a plurality of fabric products using the fabric based on the corrected image of the fabric and the input information associated with the fabric, and generate a 3D image of the plurality of fabric products placed in a pre-modeled 3D space.

9. The electronic device of claim 8, wherein the at least one processor is configured to receive information about a thickness and a weight of the fabric.

10. The electronic device of claim 8, wherein the at least one processor is configured to perform correction for at least one of shadow, local illumination inhomogeneity, distortion, color, brightness, or pattern of the image of the fabric.

11. The electronic device of claim 8, wherein the at least one processor is configured to generate 3D still images and 3D moving images corresponding to information associated with the plurality of fabric products.

12. The electronic device of claim 8, wherein the at least one processor is configured to store the generated 3D images in the memory.

13. The electronic device of claim 8, wherein the memory includes a storage space for each fabric type, and
the at least one processor is configured to classify the generated 3D images by fabric type and store the classified 3D images in each of the storage spaces.
